(19) United States
(12) Patent Application Publication
(10) Pub. No.: US 2024/0299936 A1
(43) Pub. Date: Sep. 12, 2024

(54) WELL ASSEMBLIES ENABLING OPTICAL ACCESS THEREIN AND RELATED SYSTEMS AND METHODS

(71) Applicants: ILLUMINA, INC., San Diego, CA (US); ILLUMINA CAMBRIDGE LIMITED, Cambridge (GB)

(72) Inventors: Paul Crivelli, San Diego, CA (US); Justin Davidson, Solana Beach, CA (US); Sébastien Ricoult, Sawston (GB)

(21) Appl. No.: 18/280,651

(22) PCT Filed: Mar. 1, 2022
(86) PCT No.: PCT/US22/18352

§ 371 Date: Sep. 6, 2023

Related U.S. Application Data
(60) Provisional application No. 63/158,236, filed on Mar. 8, 2021.

(51) Int. Cl. B01L 3/00

(52) U.S. Cl. CPC B01L 3/502715; B01L 2200/16; B01L 2300/123; B01L 2400/0622; B01L 2400/088

(57) ABSTRACT

Well assemblies enabling optical access therein and related systems and methods are disclosed. In accordance with an implementation, an apparatus includes a body, dry reagent, and a cover. The body defines a well and has an opening, an aperture, and a field of view (FOV) enabling optical access from the aperture to the well. The dry reagent is contained within the well. The cover is coupled to the body and covering the opening.

### RELATED APPLICATION

This application claims the benefit of and priority to U.S. Provisional Patent Application No. 63/158,236, filed Mar. 8, 2021, the content of which is incorporated by reference herein in its entireties and for all purposes.

### BACKGROUND

Reagent cartridges used with, for example, sequencing platforms, may include liquid reagent that is kept frozen until use. Keeping the reagent frozen may involve using additional packaging and/or dry ice when transporting the reagent and may involve keeping the reagent within a freezer at a facility. The measures taken to keep the reagent frozen can raise the cost of shipping and may cause some facilities to purchase additional or larger freezers or other equipment to store the reagent cartridges. Moreover, the use of ice packs, dry ice, and/or additional packing when shipping frozen reagent may reduce sustainability and increase waste.

### SUMMARY

Shortcomings of the prior art can be overcome and benefits as described later in this disclosure can be achieved through the provision of well assemblies enabling optical access therein and related systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a system and a reagent cartridge. The system includes a reagent cartridge receptacle, an illumination assembly including an illumination source to emit an illumination light, a sensor, and a processor. The reagent cartridge is receivable within the reagent cartridge receptacle and includes a well assembly. The well assembly includes a body, reagent, and a cover. The body defines a well and has an opening, an aperture, and a field of view (FOV) enabling optical access from the aperture to the well. The reagent is contained within the well and the cover is coupled to the body and covers the opening. The illumination assembly is positioned to direct the illumination light through the aperture and the sensor is positioned to capture light.

In accordance with a second implementation, an apparatus includes a body, dry reagent, and a cover. The body defines a well and has an opening, an aperture, and a field of view (FOV) enabling optical access from the aperture to the well. The dry reagent is contained within the well. The cover is coupled to the body and covering the opening.

In accordance with a third implementation, a method includes directing an illumination light through an aperture of a body of a well. The body has an opening, the aperture, and a field of view (FOV) enabling optical access from the aperture to the well, a cover coupled to the body and covering the opening, and dry reagent contained within the well. The method also includes capturing light and processing illumination data associated with the light to determine a parameter value associated with the dry reagent contained within the well.

In accordance with a fourth implementation, an apparatus includes a body and a cover. The body defines a well having an opening, an aperture, and a field of view (FOV) enabling optical access from the aperture to the well and the cover is coupled to the body and covering the opening.

In further accordance with the foregoing first, second, third, and/or fourth implementations, an apparatus and/or method may further include or comprise any one or more of the following:

In an implementation, a membrane is coupled to a surface of the body and a fluidic line is defined between the membrane and the body and a membrane valve selectively controls a flow of the liquid between the well and the fluidic line.

In another implementation, the membrane defines an opening aligned with the aperture.

In another implementation, the body includes an inner portion and an outer portion.

In another implementation, the inner portion is substantially transparent and includes the aperture and the outer portion is substantially opaque.

In another implementation, the light captured by the sensor includes one or more of reflective light, emissive light, or the illumination light emitted by the illumination assembly and the inner portion is substantially transparent to one or more of at least the reflective light, the emissive light, or the illumination light.

In another implementation, the inner portion includes Cyclic Olefin Copolymer (COC) and the outer portion includes Polypropylene.

In another implementation, the inner portion includes a flange and the outer portion is overmolded over the flange.

In another implementation, the outer portion includes a tapered surface that redirects the FOV toward the well.

In another implementation, the reagent within the well is within the FOV.

In another implementation, the inner portion includes a second aperture and the outer portion includes a second tapered surface that redirects the FOV toward the second aperture.

In another implementation, a headspace within the well is within the FOV.

In another implementation, the body includes a base that includes the aperture and the second aperture.

In another implementation, a central axis of the aperture and a central axis of the second aperture are substantially parallel.

In another implementation, the inner portion and the outer portion are concentric.

In another implementation, the inner portion includes a second aperture and wherein the outer portion includes a first tapered surface and a portion of the body defining the well includes a second tapered surface. The first tapered surface and the second tapered surface redirect the FOV between the aperture and the second aperture.

In another implementation, the first tapered surface opposes the second tapered surface.

In another implementation, the inner portion includes a second aperture and a portion of the body defining the well includes a tapered surface that redirects the FOV between the aperture and the second aperture.

In another implementation, the sensor generates illumination data using the light captured and the processor and processes the illumination data to determine a parameter value associated with the reagent contained within the well.

In another implementation, the parameter value includes a moisture content value.

In another implementation, the parameter value includes an oxygen content value.

In another implementation, the parameter value includes a concentration value of at least one component of the reagent.

In another implementation, the reagent includes a dry reagent.

In another implementation, the reagent includes a rehydrated reagent.

In another implementation, the reagent cartridge includes a liquid reservoir containing a liquid.

In another implementation, the body includes a second aperture having a central axis that is substantially orthogonal to a central axis of the aperture and a portion of the body defining the well includes a tapered surface that redirects the FOV between the aperture and the second aperture.

In another implementation, the apparatus includes a venting membrane coupled to the body and covering the dry reagent.

In another implementation, the body includes an internal step and the venting membrane is coupled to the internal step.

In another implementation, the venting membrane is positioned between the dry reagent and the cover.

In another implementation, the aperture includes a flat exterior surface of the well.

In another implementation, the cover includes an impermeable barrier.

In another implementation, the impermeable barrier includes foil.

In another implementation, the method includes redirecting the FOV.

In another implementation, redirecting the FOV includes redirecting the FOV toward the well.

In another implementation, redirecting the FOV includes redirecting the FOV toward a headspace within the well.

In another implementation, redirecting the FOV includes redirecting the FOV toward the dry reagent.

In another implementation, redirecting the FOV includes redirecting the FOV toward a second aperture and capturing the light includes capturing the light at the second aperture.

In another implementation, the parameter value includes a moisture content value.

In another implementation, the parameter value includes an oxygen content value.

In another implementation, the parameter value includes a concentration value of at least one component of the dry reagent.

In another implementation, the light captured by the sensor is less than all of the illumination light emitted by the illumination assembly.

In another implementation, the light captured by the sensor includes one or more of reflective light, emissive light, or the illumination light emitted by the illumination assembly.

In another implementation, capturing the light includes capturing one or more of reflective light, emissive light, or the illumination light emitted by the illumination assembly.

In another implementation, capturing the light includes capturing less than all of the illumination light directed through the aperture.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is an isometric cross-sectional view of a well assembly that can be used to implement the well assembly of FIG. 1.

FIG. 3 is an isometric cross-sectional view of another well assembly that can be used to implement the well assembly of FIG. 1.

FIG. 4 is a detailed isometric cross-sectional view of another well assembly that can be used to implement the well assembly of FIG. 1.

FIG. 5 is a detailed isometric cross-sectional view of another well assembly that can be used to implement the well assembly of FIG. 1.

FIG. 6 is a detailed isometric cross-sectional view of another well assembly that can be used to implement the well assembly of FIG. 1.

FIG. 7 is a cross-sectional view of another well assembly that can be used to implement the well assembly of FIG. 1.

FIG. 8 is an isometric view of the well assembly of FIG. 7.

FIG. 9 illustrates a flowchart for a method of enabling a parameter value of dry reagent to be determined using the system of FIG. 1.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of this disclosure is directed toward reagent cartridges that enable non-destructive moisture content tests to be performed and include one or more two-part reagent reservoirs that enable cost-effective, cartridge-based liquid metering, mixing, and dispensing. These two-part reagent reservoirs include a liquid reservoir containing liquid and a dry reagent well assembly including a dry reagent well containing dry reagent and a hydrophobic venting membrane covering an opening of the well. While the venting membrane deters cross-contamination between adjacent wells and allows air to vent through the venting membrane during, for example, a lyophilization process, the position of the venting membrane over the well makes determining a moisture value of the dried reagent difficult, especially when a body of the reagent reservoir is formed of an opaque material such as polypropylene.

To enable non-destructive moisture content tests to be performed, the well assemblies in accordance with this disclosure include at least one aperture and a field of view (FOV) that provide optical access between the aperture(s) and the well. In some implementations, the reagent within the well is within the FOV and, thus, the moisture content value is determined based on the reagent itself. In other implementations, a headspace of the well above the reagent is within the FOV and, thus, the moisture content of the reagent is inferred based on an assumed substantial equilibrium between the reagent and the head space in the well. In other implementations, assessing the headspace may include determining an oxygen content value of the headspace, which may be advantageous to determine when using oxygen sensitive reagents. However, other parameter values may be determined using the disclosed implementations.

To redirect the FOV toward the well and/or out of the corresponding aperture, the well assemblies can include one or more tapered surfaces (e.g., folding mirrors). In some implementations, an outer portion of the body of the reagent reservoir includes the one or more tapered surfaces and an inner portion of the body of the reagent reservoir includes the one or more apertures and defines at least a portion of the FOV. The outer portion may be substantially opaque and made from polypropylene and the inner portion may be substantially transparent and made from Cyclic Olefin Copolymer (COC). However, different materials may prove suitable.

Regardless of the orientation of the FOV or how the FOV is redirected, the aperture and the FOV provide optical access to the well and enable an illumination assembly to direct illumination light through the aperture and along the FOV and for an illumination capture arrangement to capture the light and generate illumination data. An associated processor may process the illumination data and determine a moisture value associated with the dry reagent contained within the well. In some implementations, the illumination assembly, the illumination capture arrangement, and the processor are used to perform a quality-check after the lyophilization process takes place and/or before the reagent cartridge is used. Thus, the illumination assembly, the illumination capture arrangement, and the processor may be part of an instrument used to perform an analysis on one or more samples of interest. Alternatively, a standalone instrument may be used for quality control after manufacturing that is separate from the instrument and used to perform the analysis on the one or more samples of interest.

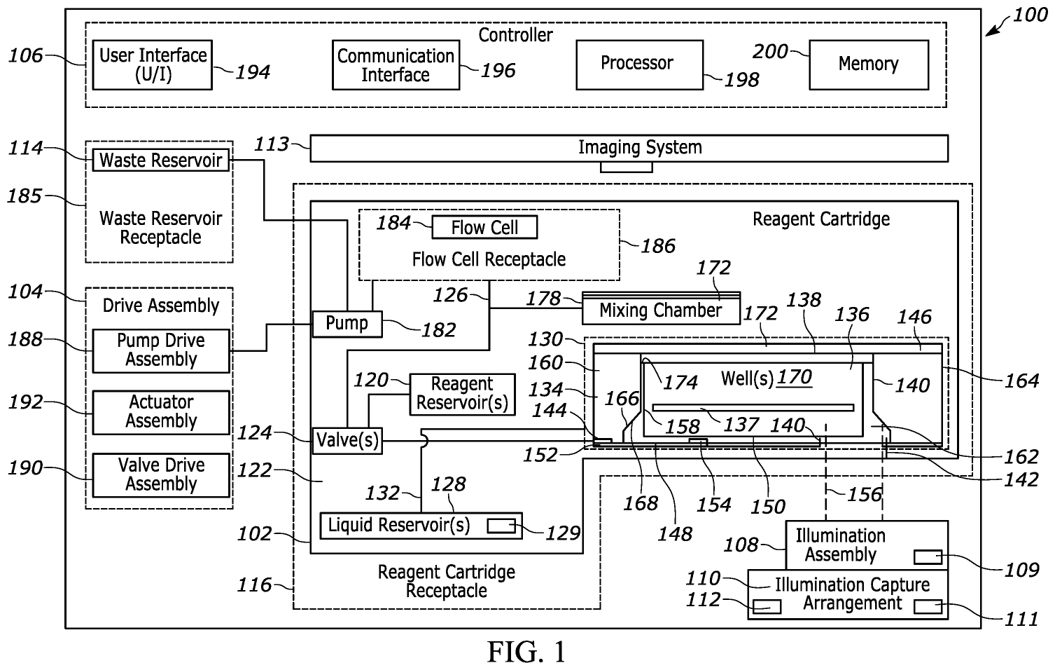

FIG. 1 illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). In the implementation shown, the system 100 receives a reagent cartridge 102 and includes, in part, a drive assembly 104 and a controller 106. The system 100 also includes an illumination assembly 108 including an illumination source 109 to emit an illumination light, an illumination capture arrangement 110 including optical components 111 and a sensor 112, an imaging system 113, and a waste reservoir 114. In other implementations, the waste reservoir 114 may be included with the reagent cartridge 104. The controller 106 is electrically and/or communicatively coupled to the drive assembly 104, the illumination assembly 108, the illumination capture arrangement 110, and the imaging system 113 and causes the drive assembly 104, the illumination assembly 108, the illumination capture arrangement 110, and/or the imaging system 113 to perform various functions as disclosed herein.

The reagent cartridge 102 carries the sample of interest. The drive assembly 104 interfaces with the reagent cartridge 102 to rehydrate dry reagents and to flow one or more rehydrated reagents (e.g., A, T, G, C nucleotides) through the reagent cartridge 102 that interact with the sample.

In an implementation, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, the imaging system 113 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 113 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 104 interfaces with the reagent cartridge 102 to flow another reaction component (e.g., a reagent) through the reagent cartridge 102 that is thereafter received by the waste reservoir 114 and/or otherwise exhausted by the reagent cartridge 102. The reaction component performs a flushing operation that chemically cleaves the fluorescent label and the reversible terminator from the sstDNA. The sstDNA is then ready for another cycle.

Referring to the reagent cartridge 102, in the implementation shown, the reagent cartridge 102 is receivable within a cartridge receptacle 116 of the system 100 and includes reagent reservoirs 120, a body 122, one or more valves 124, and fluidic lines 126. The reagent reservoirs 120 may contain fluid (e.g., reagent and/or another reaction component) and the valves 124 may be selectively actuatable to control the flow of fluid through the fluidic lines 126. One or more of the valves 124 may be implemented by a valve manifold, a rotary valve, a pinch valve, a flat valve, a solenoid valve, a reed valve, a check valve, a piezo valve, etc. If a rotary valve is used, the reagent cartridge 102 and/or the system 100 may include the valve(s) 124.

The body 122 may comprise or be formed of solid plastic using injection molding techniques and/or additive manufacturing techniques. In some implementations, the reagent reservoirs 120 are integrally formed with the body 122. In other implementations, the reagent reservoirs 120 are separately formed and coupled to the body 122. The reagent reservoirs 120 and/or the reagent cartridge 102 may include polypropylene and/or cyclic olefin copolymer (COC) with an over molded Santoprene thermoplastic elastomer (TPE) or another thermoplastic elastomer. However, other materials may prove suitable for the reagent reservoirs 120 and/or the reagent cartridge 102.

In the implementation shown, one or more of the reagent reservoirs 120 includes a liquid reservoir 128 containing liquid 129 and a well assembly 130 couplable to the liquid reservoir 128. The liquid reservoir 128 and/or the well assembly 130 may be considered modular components that may be coupled together using a coupling 132 such as a snap-fit connection or another fastener. Alternatively, the liquid reservoir 128 and the well assembly 130 may be separate components that are fluidically coupled but the coupling 132 itself may not be included.

The well assembly 130 includes a body 134 defining a well 136 containing dry reagent 137 and having an opening 138, an aperture 140, and a field of view (FOV) 142 enabling optical access from the aperture 140 to the well 136. The aperture 140 may include a compound parabolic len(s) or other optical components. The body 134 also includes a port 144 that is couplable to the liquid reservoir 128 and may be a septum or another fluidic connection.

The well assembly 130 includes a cover 146 that is coupled to the body 134 and covers the opening 138. The cover 146 may be a liquid impermeable barrier such as aluminum foil or a thin plastic sheet(s) that extends over the opening 138 and reduces the likelihood and may even prevent dry reagent 137 contained within the well 136 from being inadvertently rehydrated, or at least reduces the rate at which the dry reagent 137 contained within the well 136 is rehydrated, via the ingress of moisture.

In the implementation shown, the illumination assembly 108 is positioned to direct the illumination light through the aperture 140 and the illumination capture arrangement 110 is positioned to capture light. The illumination capture arrangement 110 may capture less than all of the illumination light emitted by the illumination assembly 108 and the light captured may include reflective light, emissive light, and/or the illumination light emitted by the illumination assembly 108.

The illumination assembly 108 may emit near infrared light and/or a laser and the illumination capture arrangement 110 may be a spectrometer (e.g., an optical spectrometer). The illumination capture arrangement 110 is shown including the optical components 111 and the sensor 112. The optical components 111 may be a lens or a set of lenses and the sensor 112 may be an optical sensor, a photodetector, a CMOS sensor, and/or a camera sensor. The sensor 112 may capture light/illumination that can be converted into one or more signals that can be used to represent an image (e.g., image data) or, more generally, may be used to convert the light/illumination to one or more signals. While the illumination capture arrangement 110 is shown in FIG. 1, in other implementations, the illumination capture arrangement 110 may be omitted. In such implementations, the sensor 112 may be included and used to capture the light/illumination.

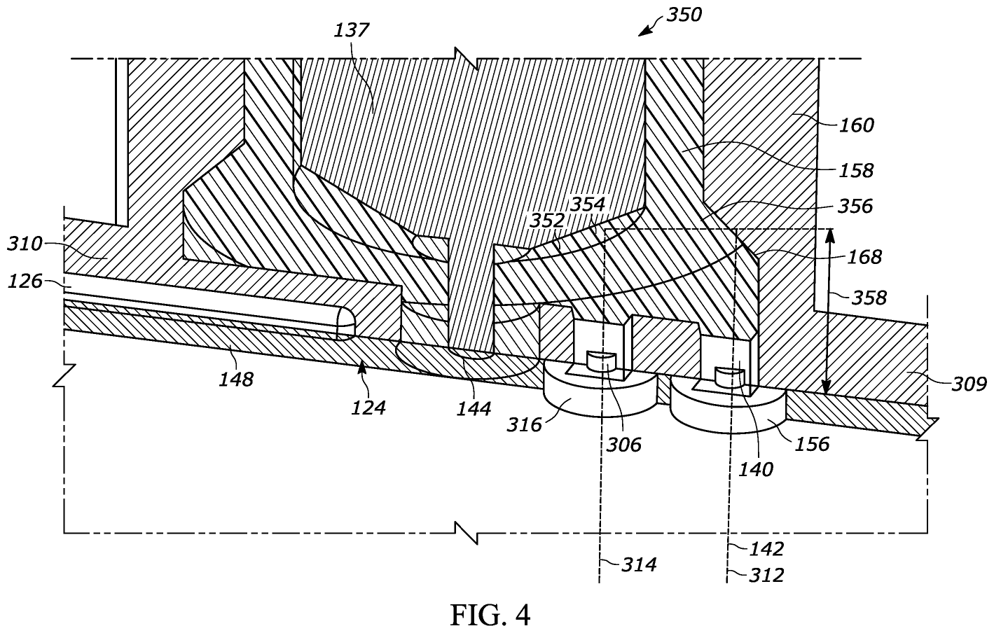

When the illumination capture arrangement 110 captures the light at the aperture 140, the light may be associated with a reflection of the illumination light emitted by the illumination source 109. In other implementations (see, FIGS. 4-6), the illumination light may pass through the aperture 140 and light may be captured by the illumination capture arrangement 110 at a different aperture.

Regardless of how the light is accessed by the illumination capture arrangement 110 and converted to illumination data, the controller 106 can access and process the illumination data and, in response to the processing, determine a parameter value associated with the dry reagent 137 contained within the well 136. In implementations when the parameter value is a moisture content value, the parameter value may be determined by comparing the illumination data to reference moisture content values. For example, an intensity value of the light captured may be compared to reference values associated with a particular moisture content value. The reference moisture content values may be associated with a standard curve linking moisture content and images of the lyophilized materials obtained using, for example, a Karl Fisher, a destructive approach. In other implementations, the parameter value may be an oxygen content value and/or a concentration value of one or more components of the reagent. Advantageously, the aperture 140 of the reagent cartridge 102 and the related components 108, 110 of the system 100 enable non-destructive quality checks to be performed to determine, for example, the moisture value of the dry reagent 137.

To determine if the determined moisture content value is within a threshold of the reference moisture content value, the system 100 may compare the determined moisture content value to the reference moisture content value. Based on the results of the comparison, the system 100 may generate an alert (e.g., an audible alert and/or a visual alert). Additionally or alternatively, if the system 100 determines that the reference moisture content value is within the threshold of the reference moisture content value, the system 100 may enable subsequent analyses to take place. However, if the system 100 determines that the reference moisture content value is outside of the threshold of the reference moisture content value, the system 100 may prevent or otherwise deter subsequent analyses from taking place. While the above example mentions determining a moisture content value and comparing the determined moisture content value to a reference moisture content value, the system 100 and/or any of the disclosed implementations may be used more generally to determine a parameter value associated with the dry reagent contained within the well. The parameter value may be associated with the moisture content value, an oxygen content value, and/or a concentration value of at least one component of the dry reagent or rehydrated reagent.

Referring still to the well assembly 130 of FIG. 1, in the implementation shown, a membrane 148 is coupled to a surface 150 of the body 134 and a fluidic line 152 is defined between the membrane 148 and the body 134. The well assembly 130 also includes a membrane valve 154 that selectively controls a flow of the liquid into and out of the well 137. The membrane 148 also defines an opening 156 that is aligned with the aperture 140 to allow the FOV 142 to pass through both the opening 156 and the aperture 140 of the well assembly 130.

In the implementation shown, the body 134 includes an inner portion 158 and an outer portion 160. The inner portion 158 may be substantially transparent and includes the aperture 140 and the outer portion 160 may be substantially opaque. As such, the inner portion 158 allows optical access within the well 136 and the outer portion 160 deters photo bleaching of the dry reagent 137 contained within the well 136 and may be made of a material that is more desirable to laser weld. For example, the inner portion 158 may include Cyclic Olefin Copolymer (COC) and the outer portion 160 may include Polypropylene. Thus, the inner portion 158 may be clear or otherwise transparent to the illumination light from the illumination assembly 108 and the outer portion 160 may be black. Thus, the inner portion 158 may be substantially transparent to one or more of the illumination light, reflective light, and/or emissive light and may not necessarily be transparent to all wavelengths. However, the inner portion 158 and/or the outer portion 160 may be made of any material and/or have any color.

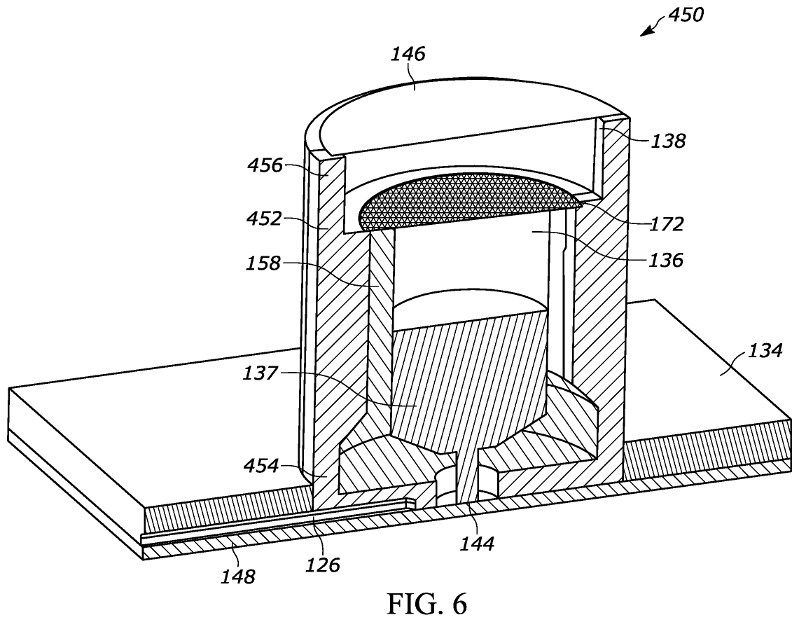

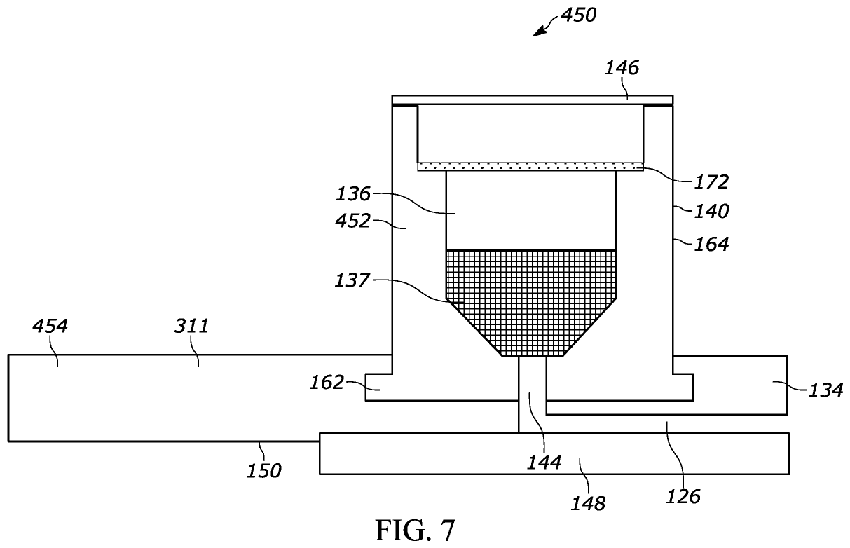

Referring still to the well assembly 130, as shown, the inner portion 158 includes a flange 162 and the outer portion 160 is overmolded over the flange 162. The interaction between the flange 162 and the outer portion 160 secures the inner portion 158 relative to the outer portion 160. However, in other implementations, the inner portion 158 and the outer portion 160 may be coupled in a different way. Alternatively, the outer portion 160 may be omitted and/or the FOV 142 may pass through the aperture 140 on a flat surface of the body 134 of the well assembly 130 (see, for example, FIGS. 6 and 7). The flat surface of the body 134 may be the surface 150 on the bottom of the well assembly 130 or a flat exterior surface 164 of the body 134 on the side of the well assembly 130.

In the implementation shown, the flange 162 includes a tapered surface 166 that mates with a corresponding tapered surface 168 of the outer portion 160. Because the outer portion 160 may be substantially opaque, the tapered surface 166 of the outer portion 160 may act as a folding mirror that redirects the FOV 142 toward the well 136 or between the well 136 and the aperture 140. The FOV 142 may be redirected toward the dry reagent 137 or may be redirected toward a headspace 170 within the well 136 and/or may be redirected toward a second aperture different from the aperture 140.

The well assembly 130 also includes a venting membrane 172 that is coupled to the body 134 and covers the dry reagent 137. Specifically, the body 134 includes an internal step 174 that the venting membrane 172 is coupled to, thereby allowing the venting membrane 172 to span across the opening 138 and be positioned between the dry reagent 137 and the cover 146. The venting membrane 172 may be a hydrophobic vent that allows liquid from the liquid reservoir 128 to be flowed into the well 136 as the venting membrane 172 vents gas contained within the well 136. While the venting membrane 172 is included in the well assembly 130 of FIG. 1, the venting membrane 172 may alternatively be omitted.

Regardless of whether the venting membrane 172 is included, the liquid reservoir 128 may contain liquid 176 such as a buffer or water and the well 136 may contain the lyophilized reagent (e.g., freeze-dried reagent) 137. The dry reagent 137 may be a cake, microspheres, spray-dried powder, lyobeads, and/or a powder. The cover 146 and/or the venting membrane 172 may retain the dry reagent 137 within the well 136.

To mix the liquid 129 and the dry reagent 137, the liquid 173 and the dry reagent 137 may be flowed between the well 136 and one of the fluidic lines 126 or between the well 136 and a mixing chamber 178. Thus, the disclosed examples may also be used to mix the liquid and the dry reagent 137. The mixing chamber 178 is shown including a venting membrane 172 and in some implementations, includes a mixer such as a magnet or a stir rod to further mix the liquid and the dry reagent. While the mixing chamber 178 is shown downstream of the well 136, the mixing chamber 178 may alternatively be disposed upstream of the well 136. However, the mixing chamber 178 may be positioned in a different location or omitted.

The liquid 129 and/or the dry reagent 137 may be flowed into and out of the well 136 and/or the fluidic lines 126 using positive pressure, negative pressure, or both. In the implementation shown, the reagent cartridge 102 includes a pump 182 positioned between a flow cell 184 and the waste reservoir 114. As used herein, a “flow cell” can include a device having a lid extending over a reaction structure to form a flow channel therebetween that is in communication with a plurality of reaction sites of the reaction structure. Some flow cells may also include a detection device that detects designated reactions that occur at or proximate to the reaction sites. The pump 182 may be implemented by a syringe pump, a peristaltic pump, a diaphragm pump, etc. While the pump 182 may be positioned between the flow cell 184 and the waste reservoir 114, in other implementations, the pump 177 may be positioned upstream of the flow cell 184 or omitted entirely.

In the implementation shown, the reagent cartridge 102 is in fluid communication with the flow cell 184 and the waste reservoir 114 may be selectively receivable within a waste reservoir receptacle 185 of the system 100. The flow cell 184 is shown being carried by the reagent cartridge 102 and is received within a flow cell receptacle 186. Alternatively, the flow cell 184 can be integrated into the reagent cartridge 102. In such implementations, the flow cell receptacle 186 may not be included or, at least, the flow cell 184 may not be removably receivable within the reagent cartridge 102. As a further alternative, the flow cell 184 may be separate from the reagent cartridge 102.

Regardless of the arrangement between the reagent cartridge 102 and the flow cell 184, the liquid reservoir 128 may be filled with the liquid 129 prior to shipping or may be filled by an individual and/or the system 100 prior to use. Because the well 136 may house the dry reagent and not liquid reagent, the well assembly 130 may be ambient shipped and/or stored. Such an approach may simplify storage requirements, reduce shipping costs, and increase the speed of workflows by, for example, avoiding thaw time before the reagent may be used. While the liquid reservoir 128 is mentioned housing liquid and the well 136 is mentioned housing dry reagent, the liquid reservoir 128 and/or the well 136 may contain another substance(s) (e.g., solids and/or liquids) or the liquid reservoir 128 and/or the well 136 may be empty.

Referring now to the drive assembly 104, in the implementation shown, the drive assembly 104 includes a pump drive assembly 188, a valve drive assembly 190, and an actuator assembly 192. The pump drive assembly 188 interfaces with the pump 182 to pump fluid through the reagent cartridge 102 and the valve drive assembly 190 interfaces with the valve 124 to control the position of the valve 124. The actuator assembly 192 interfaces with the cover 146 to pierce the cover 146 when the cover 146 is formed of foil or another pierceable material.

Referring to the controller 106, in the implementation shown, the controller 106 includes a user interface 194, a communication interface 196, one or more processors 198, and a memory 200 storing instructions executable by the one or more processors 198 to perform various functions including the disclosed implementations. The user interface 194, the communication interface 196, and the memory 200 are electrically and/or communicatively coupled to the one or more processors 198.

In an implementation, the user interface 194 receives input from a user and provides information to the user associated with the operation of the system 100 and/or an analysis taking place. The user interface 194 may include a touch screen, a display, a key board, a speaker(s), a mouse, a track ball, and/or a voice recognition system. The touch screen and/or the display may display a graphical user interface (GUI).

In an implementation, the communication interface 196 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 198 and/or the system 100 may include one or more of a processor-based system(s) or a microprocessor-based system(s). In some implementations, the one or more processors 198 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 200 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

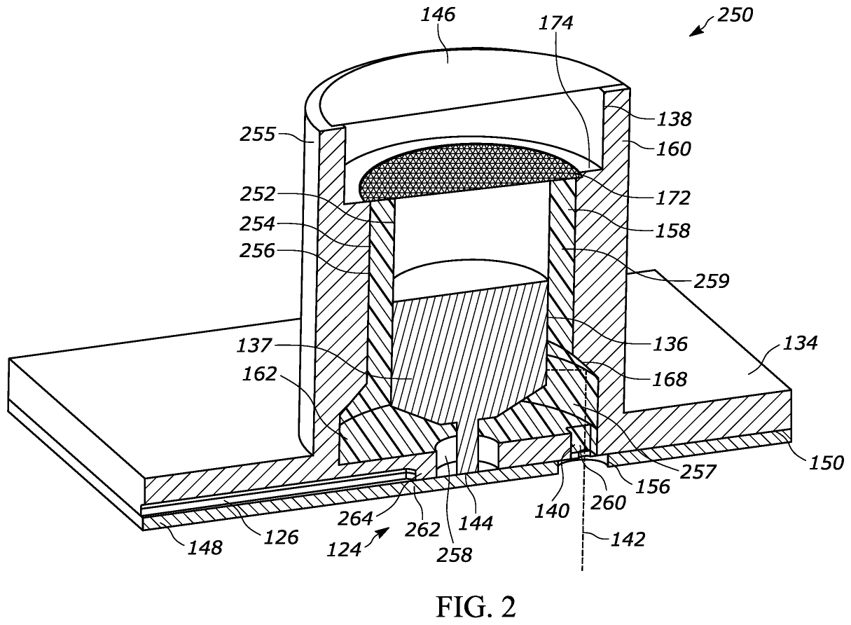

FIG. 2 is an isometric cross-sectional view of a well assembly 250 that can be used to implement the well assembly 130 of FIG. 1. In the implementation shown, the well assembly 250 includes the body 134 defining the well 136 and includes the inner portion 158 and the outer portion 160 that are concentric with one another. The inner portion 158 includes a lower portion 257 with a first diameter, an upper portion 259 with a second smaller diameter, and the tapered portion 269 between the lower and upper portions 257, 259 which diverges from the narrower upper portion 259 to the wider lower portion 257.

The well assembly 250 also includes the FOV 142 that is illustrated in dashed lines. The FOV 142 is redirected between the well 136 and the aperture 140 by the tapered surface 168 of the outer portion 160. While the tapered surface 169 is shown having an angle of approximately 45° and is arranged to direct the FOV 142 toward the dried reagent 137, the FOV 142 may be redirected in different ways into and out of the well assembly 250 to enable a moisture content value of the dry reagent 137 to be determined. In some examples, the tapered surface may have an angle of between 40° and 50° or between 30° and 60°.

To allow optical access into the well 136 and/or to facilitate an injection molding process used during manufacturing, the inner portion 158 is shown extending through the outer portion 160 and the port 144 such that a portion 258 of the inner portion 158 forming the port 144 and a portion 260 of the inner portion 158 forming the aperture 140 are flush with and/or abut the membrane 148. The inner portion 158 is shown having a curved inner surface 252 and a curved outer surface 254 and the outer portion 160 is shown having a curved outer surface 255 and a curved inner surface 256 that mates with and/or corresponds to the outer surface 254 of the inner portion 158.

The cross-sectional view of FIG. 2 also shows the valve 124 being implemented by a membrane valve. The membrane 148 is locally bonded to the body 134 of the well assembly 130, while a portion 262 of the membrane 148 below a valve seat 264 formed by the body 134 is not bonded to the membrane 148 to provide fluidic passage through the valve 124.

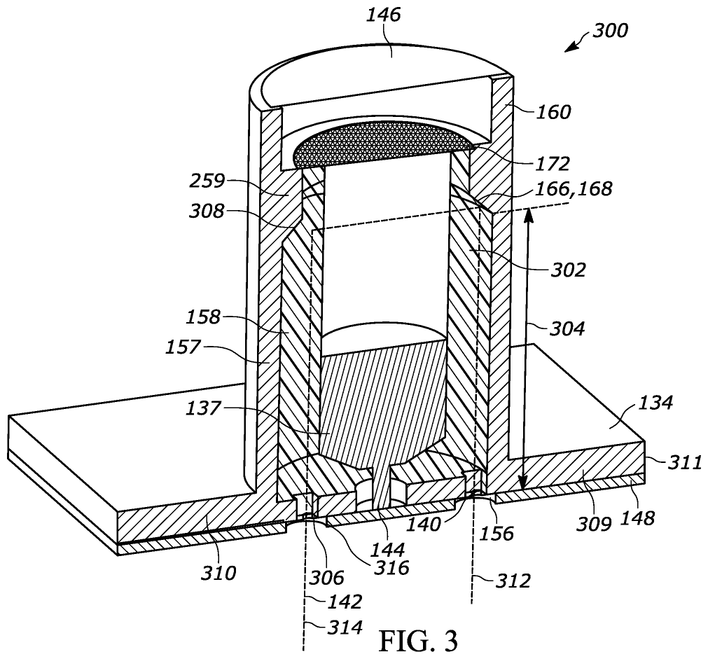

FIG. 3 is an isometric cross-sectional view of another well assembly 300 that can be used to implement the well assembly 130 of FIG. 1. The well assembly 300 of FIG. 3 is similar to the well assembly of FIG. 2. However, in contrast, the well assembly 300 of FIG. 3 includes a flange 302 having a height 304 to position the tapered surfaces 166, 168 above the dry reagent 137 and allow the headspace 170 to be within the FOV 142 (shown in dashed lines).

The inner portion 158 also includes a second aperture 306 and the outer portion 160 includes a second tapered surface 308 that may redirect the FOV 142 toward the second aperture 306 or the tapered surface 168. The apertures 140, 306 are positioned approximately 180° relative to one another and are part of a base 311 of the body 134 of the well assembly 130. The apertures 140, 306 are also shown having axes 312, 314 that are substantially parallel. As set forth herein, the phrase “substantially parallel” means between about +/−5° of parallel including parallel itself and the phrase “substantially orthogonal” means between about +/−5° of orthogonal including orthogonal itself. Put another way, the phrases “substantially parallel” and “substantially orthogonal” may account for manufacturing tolerances.

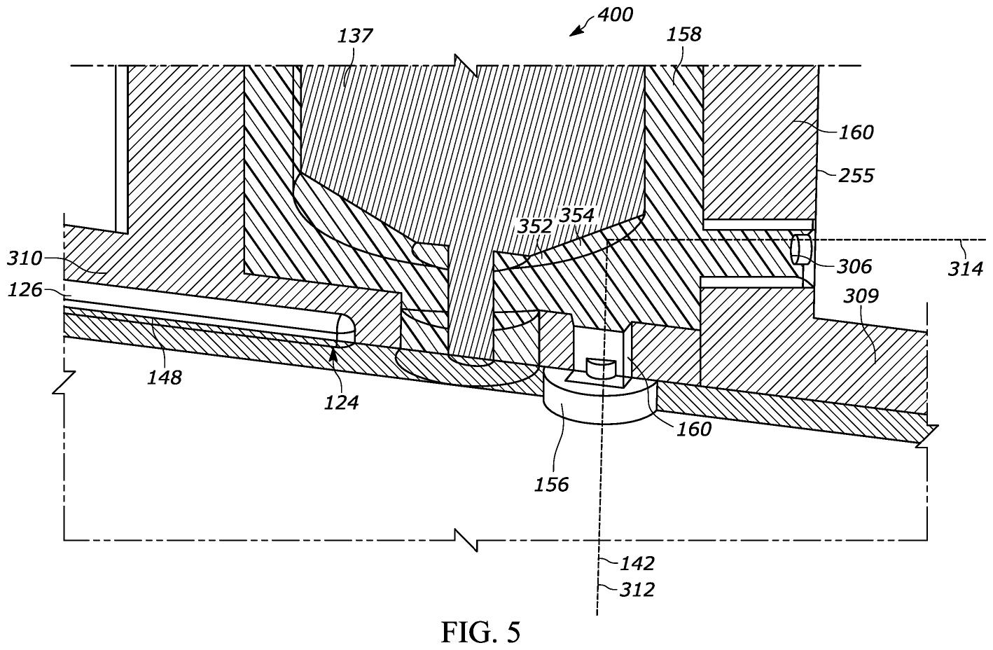

The tapered surfaces 168, 308 oppose one another and redirect the FOV 142 between the apertures 140, 306. Thus, the FOV 142 enters and exits the well assembly 300 of FIG. 3 at different locations with the aperture 140 being on a first side 309 of the port 144 and the second aperture 306 being on a second side 310 of the port 144. While the tapered surfaces 168, 308 are shown as being approximately 45° and the axes 312, 314 are shown being substantially parallel, in other implementations, the tapered surfaces 168, 308 may be any other angle and/or the axes 312, 314 may be at a different orientation relative to each other (e.g., see, FIG. 5).

As shown in FIG. 3, the membrane 148 also includes a second opening 316 that is aligned with the second aperture 306. While not viewable in FIG. 3, the fluidic line 126 and the valve 124 may be positioned approximately 90° relative to the position of the fluidic line 126 and the valve 124 shown in FIG. 2 to accommodate the second aperture 306. However, the fluidic line 126 and the valve 124 may be in any location in the implementation of FIG. 3 while still enabling the FOV 142 to pass between the apertures 140, 306.

FIG. 4 is a detailed isometric cross-sectional view of another well assembly 350 that can be used to implement the well assembly 130 of FIG. 1. The well assembly 350 of FIG. 4 is similar to the well assembly 300 of FIG. 3. However, in contrast, the well assembly 350 of FIG. 4 includes both of the apertures 140, 306 on the first side 309 of the port 144. Additionally, in contrast to the implementations of FIGS. 2 and 3, a portion 352 of the body 134 defining the well 136 includes a second tapered surface 354 that cooperates with the tapered surface 168 of the outer portion 160 to redirect the FOV 142 between the aperture 140 and the second aperture 306. The well assembly 350 of FIG. 4 is illustrated including a flange 356 having a height 358 that is slightly shorter than the height of the flange 162 of the well assembly 130 of FIG. 2 to allow the tapered surfaces 168, 354 to oppose one another and to redirect the FOV 142 into and out of the well assembly 350.

FIG. 5 is a detailed isometric cross-sectional view of another well assembly 400 that can be used to implement the well assembly 130 of FIG. 1. The well assembly 400 of FIG. 5 is similar to the well assembly 350 of FIG. 4. However, in contrast, the central axis 314 of the second aperture 306 of the well assembly 400 of FIG. 5 is substantially orthogonal to the central axis 312 of the aperture 140. The tapered surface 354 defining the well 136 redirects the FOV 142 between the aperture 140 and the second aperture 306 and the inner portion 158 extends through the outer portion 160 at the second aperture 306. Thus, the second aperture 306 may be substantially flush with or otherwise adjacent to the outer surface 255 of the outer portion 160.

FIG. 6 is a detailed isometric cross-sectional view of another well assembly 450 that can be used to implement the well assembly 130 of FIG. 1. The well assembly 450 of FIG. 6 is similar to the well assembly 250 of FIG. 5. However, in contrast, the aperture 140 and the opening 156 are omitted and the inner portion 158 includes radial portions 452 that extend from a lower portion 454 of the well assembly 450 to an upper portion 456 of the well assembly 450. The radial portions 452 allow optical access within the well 136 and, specifically, allow the moisture content value to be determined based on the reagent 137 itself or to be inferred from the headspace 170 of the well 136 above the reagent 137.

FIG. 7 is a cross-sectional view of another well assembly 450 that can be used to implement the well assembly 130 of FIG. 1. In the implementation shown, the body 134 of the well assembly 450 includes a first portion 452 that defines the well 136 in which the dry reagent 137 is disposed and includes a second portion 454 that forms the base 311. The first portion 452 may be substantially transparent and may include the flat exterior surface 164 having the aperture 140 that enables optical access within the well 136. The second portion 454 may be substantially opaque and made of a material that is relatively easily laser welded. In the implementation shown, the first portion 452 includes the flange 162 that is overmolded by the second portion 454 to couple the portions 452, 454 together. While the flange 162 is shown in FIG. 7 as being used to couple the portions 452, 454 together, another mechanical fastener and/or teeth may be included to couple the portions 452, 454 together. Additionally or alternatively, a different fastener such an adhesive may be used to couple the portions 452, 454 together.

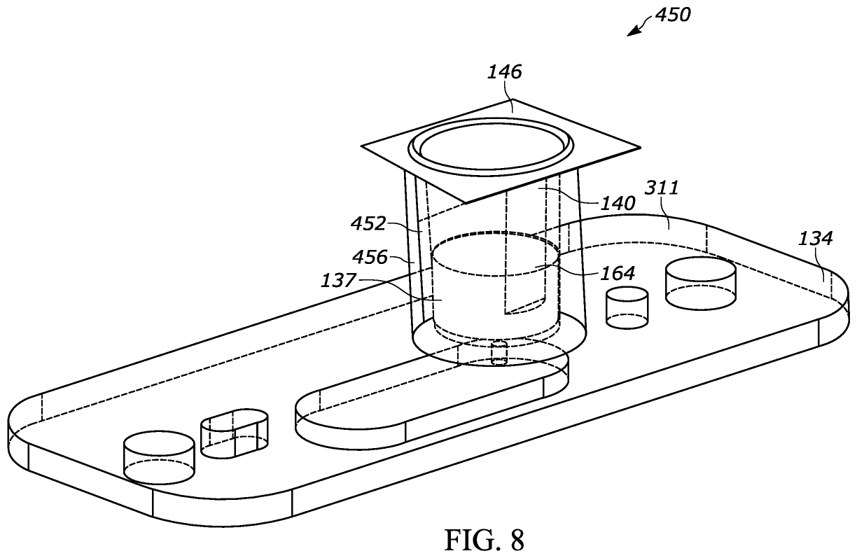

FIG. 8 is an isometric view of the well assembly 450 of FIG. 7. As shown, the flat exterior surface 164 is rectangular in shape and is surrounded by a curved outer surface 456 of the body 134.

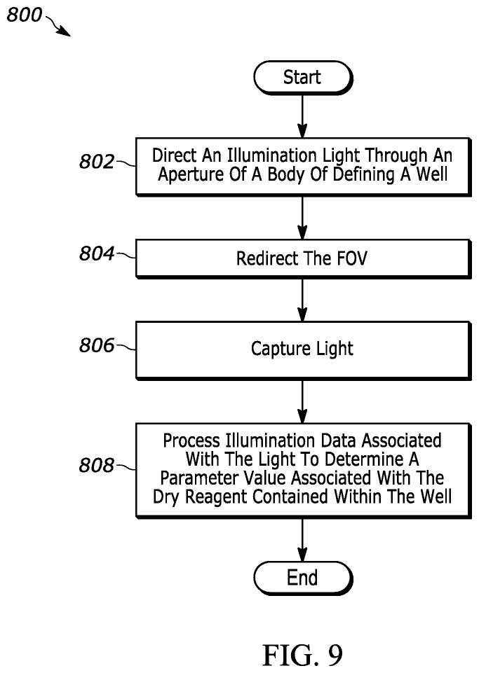

FIG. 9 illustrates a flowchart for a method of determining a parameter value of the dry reagent 137 using the system 100 of FIG. 1. The order of execution of the blocks may be changed, and/or some of the blocks described may be changed, eliminated, combined and/or subdivided into multiple blocks.

The process 800 of FIG. 9 begins with the illumination light being directed through the aperture 140 of the body 122 of the well 136 (Block 802). The body 122 has the opening 138, the aperture 140, and the field of view (FOV) 142 that enables optical access from the aperture 140 to the well 136. The cover 146 is coupled to the body 134 and covers the opening 138 and the dry reagent 137 is contained within the well 136. As such, the top of the well 136 is not open and may not be visually accessed through the opening 138.

The FOV 142 is redirected (Block 804). In some implementations, redirecting the FOV 142 includes redirecting the FOV 142 toward the dry reagent 137. In other implementations, redirecting the FOV 142 includes redirecting the FOV 142 toward the headspace 170 within the well 136. The light is captured (Block 806). In some implementations, a reflection of the illumination light may be directed out of the second aperture 306 and captured by the illumination capture arrangement 110. In other implementations, a reflection of the illumination light may be directed out of the aperture 140 and received by the illumination capture arrangement 110. The illumination data associated with the light is processed to determine a parameter value associated with the dry reagent 137 contained within the well (Block 808). The parameter value may be a moisture content value, an oxygen content value, or a concentration value of at least one component of the dry reagent. In some implementations, a wavelength of light received is representative of or otherwise associated with the moisture content of the dry reagent 137. While this example mentions determining a parameter value of the dry reagent 137, in other implementations, the parameter value may be associated with rehydrated reagent. In such implementations, the parameter value can include a concentration value of at least one component of the rehydrated reagent. The processor 198 of the controller 106 may be used to process the illumination data and determine the moisture value or another parameter value of interest. While the process 800 of FIG. 9 is described in association with using the system 100 of FIG. 1, other systems may be used. For example, a quality-control assembly or a hand-held device may be used to determine the moisture content of the dry reagent 137.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a system, comprising:
a reagent cartridge receptacle;
an illumination assembly comprising an illumination source to emit an illumination light;
a sensor; and
a processor;
a reagent cartridge receivable within the reagent cartridge receptacle, the reagent cartridge, comprising:
a well assembly, comprising:
a body defining a well and having an opening, an aperture, and a field of view (FOV) enabling optical access from the aperture to the well;
reagent contained within the well; and
a cover coupled to the body and covering the opening;
wherein the illumination assembly is positioned to direct the illumination light through the aperture and the sensor is positioned to capture light.

2. The apparatus of claim 1, wherein a membrane is coupled to a surface of the body and a fluidic line is defined between the membrane and the body, further comprising a membrane valve that selectively controls a flow of liquid between the well and the fluidic line.

3. The apparatus of claim 2, wherein the membrane defines an opening aligned with the aperture.

4. The apparatus of claim 1, wherein the body comprises an inner portion and an outer portion and wherein the inner portion is substantially transparent and comprises the aperture, and the outer portion is substantially opaque.

5-7. (canceled)

8. The apparatus of claim 4, wherein the inner portion comprises a flange and the outer portion is overmolded over the flange.

9. The apparatus of claim 4, wherein the outer portion comprises a tapered surface that redirects the FOV toward the well.

10. The apparatus of claim 9, wherein the reagent within the well is within the FOV.

11. The apparatus of claim 9, wherein the inner portion comprises a second aperture and the outer portion comprises a second tapered surface that redirects the FOV toward the second aperture.

12. The apparatus of claim 11, wherein a headspace within the well is within the FOV.

13. The apparatus of claim 11, wherein the body comprises a base that includes the aperture and the second aperture.

14. The apparatus of claim 11, wherein a central axis of the aperture and a central axis of the second aperture are substantially parallel.

15. The apparatus of claim 4, wherein the inner portion and the outer portion are concentric.

16. The apparatus of claim 4, wherein the inner portion comprises a second aperture and wherein the outer portion comprises a first tapered surface and a portion of the body defining the well comprises a second tapered surface, the first tapered surface and the second tapered surface redirecting the FOV between the aperture and the second aperture.

17. The apparatus of claim 16, wherein the first tapered surface opposes the second tapered surface.

18. The apparatus of claim 4, wherein the inner portion comprises a second aperture and a portion of the body defining the well comprises a tapered surface that redirects the FOV between the aperture and the second aperture.

19. The apparatus of claim 1, wherein the sensor generates illumination data using the light captured and the processor processes the illumination data to determine a parameter value associated with the reagent contained within the well and wherein the parameter value comprises at least one of a moisture content value, an oxygen content value, or a concentration value of at least one component of the reagent.

20-27. (canceled)

28. An apparatus, comprising:
a body defining a well and having an opening, an aperture, and a field of view (FOV) enabling optical access from the aperture to the well;
dry reagent contained within the well; and
a cover coupled to the body and covering the opening.

29. The apparatus of claim 28, wherein the body comprises a second aperture having a central axis that is substantially orthogonal to a central axis of the aperture and wherein a portion of the body defining the well comprises a tapered surface that redirects the FOV between the aperture and the second aperture.

30-35. (canceled)

36. A method, comprising:
directing an illumination light through an aperture of a body of a well, the body having an opening, the aperture, and a field of view (FOV) enabling optical access from the aperture to the well, a cover being coupled to the body and covering the opening and dry reagent being contained within the well;
capturing light; and
processing illumination data associated with the light to determine a parameter value associated with the dry reagent contained within the well.

37. The method of claim 36, further comprising redirecting the FOV and wherein redirecting the FOV comprises at least one of redirecting the FOV toward the well, redirecting the FOV toward a headspace within the well, redirecting the FOV toward the dry reagent, or redirecting the FOV toward a second aperture.

38-75. (canceled)
